(19) United States
(12) Patent Application Publication
(10) Pub. No.: US 2022/0160031 A1
(43) Pub. Date: May 26, 2022

(54) DUAL-HEATER VAPORIZER DEVICES AND RELATED METHODS

(71) Applicant: 1769474 ALBERTA LTD., Edmonton (CA)

(72) Inventors: Jason Griffin, Kitchener (CA); Thai Nguyen, Kitchener (CA); Steven Fyke, Kitchener (CA); Tyler Kibler, Edmonton (CA); Felipe Simoes, Kitchener (CA)

(73) Assignee: 1769474 ALBERTA LTD., Edmonton, AB (CA)

(21) Appl. No.: 17/441,159

(22) PCT Filed: Mar. 20, 2020
(86) PCT No.: PCT/CA2020/050373

§ 371 Date: Sep. 20, 2021

Related U.S. Application Data
(60) Provisional application No. 62/821,192, filed on Mar. 20, 2019.
(60) Provisional application No. 62/951,563, filed on Dec. 20, 2019.

(51) Int. Cl. A24F 40/30; G05D 11/13; H05B 1/02; A24F 40/46; A24F 40/48; A24F 40/57; A24F 40/60; A24F 40/42

(52) U.S. Cl. CPC A24F 40/30; G05D 11/13; H05B 1/0252; A24F 40/46; H05B 2203/005; A24F 40/57; A24F 40/60; A24F 40/42; A24F 40/48

(57) ABSTRACT

A vaporizer device is provided that includes a body and a mouthpiece coupled to the body and having at least one suction opening. The device further includes a first heater for vaporizing a first vaping material, thereby forming a first vapor. The vaporizer device further includes a second heater for vaporizing a second vaping material, thereby forming a second vapor. The heaters are arranged in or operatively coupled to the body. The device includes at least one airflow conduit that delivers the first and second vapors to the at least one opening of the mouthpiece. The device may also include first and second cartridges that removably couple to the body. The vaporizer device may further include a vapor control operable to control at least one of generation and flow of the first vapor and the second vapor.

### RELATED APPLICATIONS

The present application claims priority to U.S. Provisional Patent Application No. 62/821,192 filed on Mar. 20, 2019 and to U.S. Provisional Patent Application No. 62/951,563 filed on Dec. 20, 2019, the entire contents of which are incorporated herein by reference.

### FIELD OF THE DISCLOSURE

The disclosure relates to vaporizer devices that vaporize material to produce vapor to be inhaled by a user. More particularly, the disclosure relates to portable vaporizer devices comprising a cartridge for holding material to be vaporized.

### BACKGROUND

Vaporizer devices typically heat a material, such as herbs, oils, waxes, and other materials, to create a vapor containing one or more desired extracted ingredients. Such materials may be referred to herein as “vaping materials.” The vapor can then be delivered to a user by inhalation during a “vaping” session.

A portable personal vaporizer device may typically comprise a cartridge that holds a material for use in a vaping session. The vaping material may comprise an oil or other liquid, dried plant material, a wax-base, and/or other materials. Fluid-based vaporizers typically comprise a cartridge having a fluid reservoir and a heating chamber. The heating chamber is fluidly coupled to the reservoir and receives a fluid vaping material from the reservoir, typically via a wick. One or more heating elements heat and vaporize the vaping material, which is transported via an airflow conduit to a mouthpiece. The vapor is inhaled by the user through the mouthpiece.

When a user desires to change from a first vapor composition to a second vapor composition, the user may need to remove the cartridge from the device and either change out the vaping material in the cartridge for another vaping material, or insert a different cartridge with the other vaping material. Furthermore, obtaining a vapor that is a mix of two different compositions may require mixing two vaping material in the reservoir of a single cartridge. Thus, the ability to change vapor types and/or vapor mix ratios may be limited in conventional vaporizer devices.

### SUMMARY

According to an aspect, there is provided a vaporizer device, comprising: a body: a first heater for vaporizing a first vaping material, the first heater being arranged in or operatively coupled to the body; a second heater for vaporizing a second vaping material, the second heater being arranged in or operatively coupled to the body; and a mouthpiece coupled to the body, the mouthpiece defining at least one opening; and at least one airflow conduit fluidly connecting the first and second heaters to the at least one opening of the mouthpiece.

In some embodiments, the vaporizer device further comprises a vapor control operable to control at least one of generation and flow of a first vapor from the first vaping material and a second vapor from the second vaping material according to a mode of operation.

In some embodiments, controlling the at least one of generation and flow of the first and second vapors according to the mode of operation comprises controlling the at least one of generation and flow of the first vapor and second vapors according to a mix ratio of the first and second vapors.

In some embodiments, the mode of operation is one of a plurality of modes of operation, the mix ratio is one of a plurality of mix ratios, each of the plurality of mix ratios corresponding to a respective one of the modes of operation, and the vapor control being selectively operable for each of the modes of operation.

In some embodiments, the vapor control is operable to control generation of the first and second vapors by individually and selectively controlling operation of the first and second heaters.

In some embodiments, the vapor control is operable to selectively and individually control at least one of: power levels of the first and second heaters; burn times of the first and second heaters; and pulse rates of the first and second heaters.

In some embodiments, the at least one airflow conduit comprises a first airflow conduit that fluidly connects to the first heater and a second airflow conduit that fluidly connects to the second heater, and the vapor control comprises a first airflow restriction mechanism operable to selectively restrict airflow in the first airflow conduit and a second airflow restriction mechanism operable to selectively restrict airflow in the second airflow conduit.

In some embodiments, the vaporizer device further comprises a user interface that receives user input to select the mode of operation.

In some embodiments, the vapor control is operable to: obtain at least one of time of day information and location information; and select the mode of operation as a function of at least one of the time of day information and the location information.

In some embodiments, the selected mode of operation restricts the generation or flow of one or more of the first and second vapors.

In some embodiments, the vaporizer device further comprises a first storage chamber for storing the first vaping material and a second storage chamber for storing the second vaping material.

In some embodiments, the vaporizer device further comprises a first cartridge removably couplable to the body, the first cartridge defining the first storage chamber.

In some embodiments, the body defines a first receptacle, and the first cartridges docks with the first receptacle.

In some embodiments, the first cartridge further comprises the first heater.

In some embodiments, the vaporizer device further comprises a second cartridge removably couplable to the body, the second cartridge defining the second storage chamber.

In some embodiments, the body defines a second receptacle, and the second cartridges docks with the second receptacle.

In some embodiments, the second cartridge further comprises the second heater.

In some embodiments, at least one of the first and second heaters are arranged in the body.

In some embodiments, the first storage chamber comprises a first reservoir fluidly coupled to the first heater.

In some embodiments, the second storage chamber comprises a second reservoir fluidly coupled to the second heater.

In some embodiments, the first heater comprises a first oven, the first oven defining the first storage chamber.

In some embodiments, the second heater comprises a second oven, the second oven defining the first storage chamber.

According to an aspect, there is provided a vaporizer device, comprising: a body defining; a first cartridge receptacle operable to engage a first cartridge, the first cartridge holding a first vaping material and comprising a first heater for vaporizing the first vaping material; and a second cartridge receptacle operable to engage a second cartridge, the second cartridge holding a second vaping material and comprising a second heater for vaporizing the second vaping material; a mouthpiece coupled to the body, the mouthpiece defining at least one opening; and at least one airflow conduit fluidly connecting the first and second receptacles to the at least one opening of the mouthpiece.

In some embodiments, the vaporizer device further comprises a vapor control operable to control at least one of generation and flow of a first vapor from the first vaping material and a second vapor from the second vaping material according to a mode of operation.

In some embodiments, the vapor control is operable to control generation of the first and second vapors by individually and selectively controlling operation of the first and second heaters.

In some embodiments, the vapor control is operable to selectively and individually control at least one of: power levels of the first and second heaters; burn times of the first and second heaters; and pulse rates of the first and second heaters.

According to an aspect, there is provided a method for vaporizing first and second vaping materials using a vaporizer device comprising a first heater for vaporizing the first material, a second heater for vaporizing the second material and a mouthpiece defining at least one opening fluidly connected to the first and second heaters, the method comprising: controlling at least one of generation and flow of a first vapor from the first vaping material and a second vapor from the second vaping material according to a mode of operation; and delivering at least one of the first vapor and the second vapor to the at least one opening of the mouthpiece.

In some embodiments, controlling the at least one of generation and flow of the first and second vapors according to the mode of operation comprises controlling the at least one of generation and flow of the first vapor and second vapors according to a mix ratio of the first and second vapors.

In some embodiments, controlling at least one of generation and flow of the first vapor and the second vapor according to the mode of operation comprises: generating the first vapor according to the mix ratio; and generating the second vapor according to the mix ratio.

In some embodiments, the mode of operation is one of a plurality of modes of operation, the mix ratio is one of a plurality of mix ratios, each of the plurality of mix ratios corresponding to a respective one of the modes of operation, and the method further comprising selecting the mode of operation from the plurality of modes of operation.

In some embodiments, the method further comprises receiving user input to select the mode of operation.

In some embodiments, the method further comprises at least one of time of day information and location information and selecting the mode of operation as a function of at least one of the time of day information and the location information.

In some embodiments, controlling at least one of generation and flow of the first vapor and the second vapor according to the selected mode of operation comprises restricting one or more of the first and second vapors.

Other aspects and features of the present disclosure will become apparent, to those ordinarily skilled in the art, upon review of the following description of the specific embodiments of the disclosure.

### BRIEF DESCRIPTION OF THE DRAWINGS

The present disclosure will be better understood having regard to the drawings in which:

FIG. 1 is a top plan view of a dual-cartridge vaporizer device according to an example embodiment;

FIG. 2 is a functional block diagram of the vaporizer device of FIG. 1;

FIG. 3 is a functional block diagram of a vaporizer device according to an example embodiment;

FIG. 4 is a functional block diagram of a vaporizer device according to an example embodiment;

FIG. 5 is a flowchart of a method for vaporizing at least one vaping material using a vaporizer device according to an example embodiment;

FIG. 6 is a flowchart of a method for vaporizing at least one vaping material using a vaporizer device according to an example embodiment;

FIG. 7 is a flowchart of a method for vaporizing at least one vaping material using a vaporizer device according to an example embodiment;

FIG. 8 is a top perspective view of a portable vaporizer device according to an example embodiment;

FIGS. 9 to 12 are upper perspective, top plan, side elevation, and end views, respectively, of a portable vaporizer device according to an example embodiment; and

FIG. 13 is a top cross-sectional view of the vaporizer device of FIGS. 9 to 12 taken along the line A-A in FIG. 12.

### DETAILED DESCRIPTION

A user may desire to vape more than one vaping material separately or to combine vaping materials. A first vaping material may have a first set of properties, and a second vaping material may have a second set of properties, each vaping material eliciting a distinct effect when vaporized and inhaled by the user. A user may desire to use the vaping materials at different times or to mix the vaping materials (or vapors from the vaping materials) in various combinations to achieve a desired effect when inhaled. The user may desire to use different ratios of vaping materials (or vapors from the vaping materials) at different times. It may be desirable to easily change the vaping material(s) without replacing or refilling a cartridge of the vaporizer device.

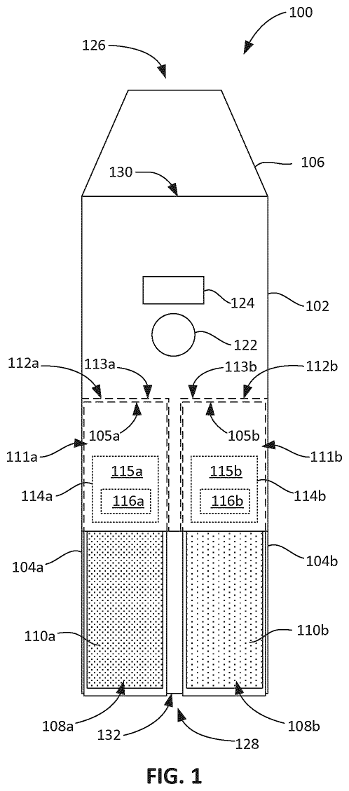

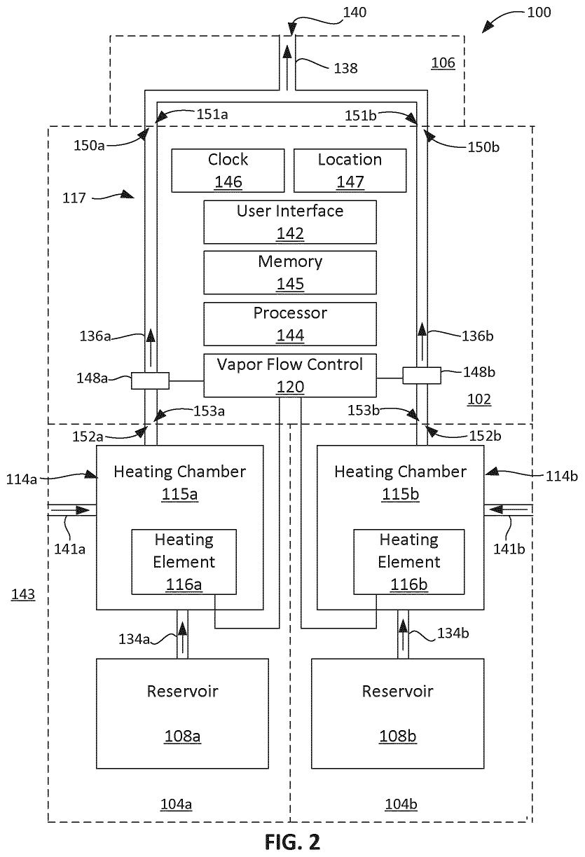

FIG. 1 is a top plan view of a dual-cartridge vaporizer device 100 according to an example embodiment. The vaporizer device 100 may be portable (e.g. handheld), but embodiments are not limited only to portable devices. The vaporizer device 100 includes a body 102 and a mouthpiece 106. The mouthpiece defines at least one opening 140 (not visible in FIG. 1, but shown in FIG. 2). Openings in mouthpiece 106 may be referred to herein as “suction openings” because a user applies suction to the openings to draw vapor therefrom.

The vaporizer device 100 comprises a first heater 114a and a second heater 114b. The term “heater” as used herein may refer to any device that transforms a vaping material into a vapor. For example, first heater 114a may be an atomizer or oven. First heater 114a in this embodiment comprises a first heating chamber 115a and a first heating element 116a coupled to first heating chamber 115a for vaporizing a first vaping material 110a. Vaporizer device 100 further comprises a second heating chamber 115b and a second heating element 116b coupled to second chamber 115b for vaporizing a second vaping material 110b. Heating chambers 115a and 115b and heating elements 116a and 116b are internal to vaporizer device 100 in this embodiment and are represented by functional blocks in stippled lines in FIG. 1 (the stippled lines in FIG. 1 indicate elements or portions thereof not normally visible in that view). The form and configuration of heating chambers 115a and 115b and heating elements 116a and 116b may vary, as will be explained in more detail below.

Vaporizer device 100 includes at least one airflow conduit (such as airflow conduit system 117 in FIG. 2) that delivers vapors from first and second heating chambers 115a and 115b through body 102 to the at least one suction opening of mouthpiece 106. Airflow conduit system 117 is described in more detail with respect to FIG. 2 below. The term “airflow conduit” used herein may refer to any structure that directs airflow along a path. An airflow conduit may, for example, comprise one or more tubular structures (such as pipes), manifolds, and/or any other suitable structure.

Vaporizer device 100 of FIG. 1 optionally includes first and second cartridges 104a and 104b, that removably couple to body 102. The cartridges are each removable from body 102 and replaceable in this embodiment. In this embodiment, first cartridge 104a includes a first reservoir 108a for holding a first vaping material 110a, and second cartridge 104b includes a second reservoir 108b for holding a second vaping material 110b. Reservoirs 108a and 108b are shown by way of example, and the disclosure is not limited to any particular type or configuration of storage chambers for storing vaping materials. First and second heating elements 116a and 116b are operable to heat and vaporize first and second vaping materials 110a and 110b respectively received from reservoirs 108a and 108b of corresponding cartridges 104a and 104b.

In other embodiments, a vaporizing device may only include one cartridge. A vaporizing device may alternatively include more than two cartridges. In some embodiments, a device may comprise a first one or more primary storage chambers (e.g. reservoir) for one or more vaping materials and/or a heater integrated in the body. The body may further be configured to receive one or more cartridges having a secondary storage chamber for one or more vaping materials and/or a secondary heater.

In the FIG. 1 embodiment, first and second vaping materials 110a or 110b may be the same vaping materials or different vaping materials. For example, first vaping material 110a in the first cartridge 104a may be a first liquid composition and second vaping material 110b in the second cartridge 104b may be a second liquid composition. The first and second liquid compositions may generate vapors with different properties. For example, the first liquid composition may contain a first one or more psychoactive compounds, while the second liquid composition may be substantially or completely non-psychoactive. The liquid compositions may, for example, be oil-based compositions.

In the FIG. 1 embodiment, first cartridge 104a includes first heater 114a, including heating chamber 115a and first heating element 116a. Second cartridge 104b includes second heater 114b, including second heating chamber 115b and second heating element 116b. First reservoir 108a is fluidly coupled to first heating chamber 115a such that first vaping material 110a flows to first heating chamber 115a. The term “fluidly coupled” or “fluidly connected” herein may refer to any coupling between first and second elements that allows a fluid composition in the first element to flow into the second element. The flow may be controlled. In some embodiments, the coupling between first reservoir 108a and first heating chamber 104a comprises a wick.

First heater 114a is operatively coupled to body 102 when first cartridge 104a is engaged with body 102. Second heater 114b is operatively coupled to body 102 when second cartridge 104b is engaged with body 102. Alternatively, in some embodiments, one or both of heaters 114a and 114b may be arranged in body 102. The term “operatively coupled” may refer to any coupling that allows heaters 114a and 114b to operate in cooperation with body 102 as described herein, and direct physical contact between heaters 114a and 114b and body 102 is not required. For example, the “operative coupling” may comprise electrical and/or fluid coupling.

Second reservoir 108b is fluidly coupled with second heating chamber 115b such that second vaping material 110b flows to second heating chamber 115b. In some embodiments, the coupling comprises a wick.

In some embodiments heating chambers 115a and 115b and heating elements 116a and 116b are integrated respectively in cartridges 104a and 104b. In some embodiments heating chambers 115a and 115b and heating elements 116a and 116b are integrated in body 102. In such embodiments, fluid flow conduits may be provided to allow first and second vaping materials 110a and 110b to flow from reservoirs 108a and 108b in cartridges 104a and 104b to heating chambers 115a and 115b in body 102. In some embodiments, reservoirs 108a and 108b are part of body 102 and cartridges 104a and 104b may be omitted. Embodiments are not limited to the specific location or configuration of first and second heaters 114a and 114b and reservoirs 108a and 108b shown in FIG. 1.

As shown in the example embodiment shown in FIG. 1, first and second cartridges 104a and 104b dock with body 102. To do so, body 102 defines first and second receptacles 112a and 112b that partially receive first and second cartridges 104a and 104b, respectively. In other embodiments, receptacles 112a and 112b may substantially or fully receive first and second cartridges 104a and 104b, respectively.

Cartridges 104a and 104b are generally cylindrically shaped in the embodiment shown in FIG. 1. Receptacles 112a and 112b are in the form of generally cylindrical recesses or cavities that are shaped complimentary to portions 111a and 111b of cartridges 104a and 104b received in the receptacles 112a and 112b. Receptacles 112a and 112b may each comprise a respective seat (not shown) that docks with the cartridges. For example, the seats may be at inner ends 113a and 113b of receptacles 112a and 112b, with each cartridge 104 and 104b having a corresponding connector (not shown) at a respective end 105a, 105b of the cartridge for engaging the corresponding seat. Thus, end 105a of first cartridge 104a may engage a seat at inner end 113a of first receptacle 112a, and end 105b of second cartridge 104b may engage a seat at inner end 113b of second receptacle 112b (or vice versa if cartridges 104a and 104b are swapped). Embodiments are not limited to any particular shape or configuration of the cartridges 104a and 104b and receptacles 112a and 112b.

The term “dock” as used herein may refer to any suitable operative coupling or engagement between first and second cartridges 104a and 104b and body 102. The engagement may comprise fluid transfer (e.g. transfer of vapor) from cartridges 104a and 104b to body 102. The engagement may also comprise electrical coupling between cartridges 104a and 104b and body 102. The electrical coupling may, for example, include transfer of power and/or control signals from body 102 to cartridges 104a and 104b.

In some embodiments, each cartridge 104a and 104b interfaces with corresponding receptacle 112a or 112b to operably couple the cartridge 104a or 104b to body 102. Each cartridge 104a or 104b may, for example, comprise electrical contacts (not shown) and/or an airflow outlet (such as outlets 152a and 152b in FIG. 2). The electrical contacts may engage corresponding electrical contacts (not shown) in receptacle 112a or 112b to provide electrical connection between cartridge 104a or 104b and body 102. The airflow outlet of each cartridge 104a and 104b may interface with an airflow inlets (such as inlets 153a and 153b in FIG. 2) of corresponding receptacle 112a or 112b.

Optionally, each cartridge 104a and 104b may comprise a respective outer wall and an inner pipe portion functioning as a conduit that defines an airflow path that extends through the cartridge. The airflow path through the cartridge may provide for air intake into heating chamber 115a or 115b and vapor output from the heating chamber. An annulus may be provided between the outer wall and the inner pipe. For each cartridge 104a and 104b, respective reservoir 108a or 108b may comprise at least a portion of the annulus.

First and second cartridges 104a and 104b may be refilled with the same vaping materials 110a and 110b or one or more different vaping materials. The positions of first and second cartridges 104a and 104b may also be swapped (i.e. first cartridge 104a docked with second receptacle 112b and second cartridge 104b docked with first receptacle 112a).

Mouthpiece 106 may be removable from body 102. In some embodiments mouthpiece 106 is replaceable. Mouthpiece 106 may connect to body 102 in any suitable manner (e.g. snap fit, friction fit, clips, etc.), and embodiments are not limited to a particular connection method. In other embodiments, the mouthpiece 106 may be integral with the body 102. Embodiments are also not limited to any particular mouthpiece shape, position, or number of suction openings in the mouthpiece.

In the embodiment shown in FIG. 2, vaporizer device 100 includes a vapor control 120 operable to control the generation and/or flow of the first and second vapors according to a mode of operation of vaporizer device 100. The mode of operation may correspond to a mix ratio of the first and second vapors. That is, the vapor control 120 may control at least one of generation and flow of the first vapor and second vapors according to the mix ratio. The term “mix ratio” refers to a ratio of the first vapor to the second vapor (or vice versa). In other words, the mix ratio may indicate the abundance of the first vapor relative to the abundance of the second vapor (or vice versa) in a mixture of the two vapors.

One of a plurality of modes of operation (e.g. different mix ratios) may be selected by a user and/or automatically selected by vaporizer device 100 based on one or more criteria. The vapor control 120 may be selectively operable for each of the modes of operation. In other words, the vapor control 120 may be capable of operating according to each of the modes, as individually selected. For example, vapor control 120 may activate flow of the first vapor, but stop flow of the second vapor according to the current mode of operation. Vapor control 120 may activate flow of both the first and second vapors and/or control a mix ratio of the first vapor and the second vapor. Vapor control 120 may control the vapor flows such that the first vapor is between 0% and 100% of the total vapor flowing through the mouthpiece 106. Optionally, the percentage of the first vapor may be set at 25%, 50% or 75% (or any other intermediate values). Thus, a user may customize the balance of the first and second vapors depending on their current wants, the current environment, etc. Vapor control 120 may be omitted in other embodiments.

In some embodiments, vaporizer device 100 includes a user interface, such as one or more buttons, for receiving user input to select a mode of operation. In the FIG. 1 embodiment, vaporizer device 100 includes a button 122 and a visual indicator 124 as user interface elements. Button 122 is operable to receive input that switches between or cycles through different vapor mix ratio settings. In other embodiments, multiple user inputs (e.g. multiple buttons) or different user interface elements may be used to obtain user input. For example, multiple buttons may be provided with each corresponding to a respective mix ratio. In some embodiments, visual indicator 124 comprises at least one light or display that provides an indication of the current mix ratio setting, as will be explained below. In some embodiments, the user interface may comprise a touchscreen that performs both input and display functions. Embodiments are not limited to any particular user interface elements, and such elements may also be omitted.

As shown, vaporizer device 100 is generally elongated with a first end 126 and an opposite second end 128. However, body 102 is not limited to any particular shape. In the FIG. 1 embodiment, mouthpiece 106 is disposed at first end 126 and cartridges 104a and 104b at second end 128, with body 102 generally therebetween. Body 102 has a first end 130 with mouthpiece 106 extending from first end 130. Body 102 has a second end 132 at which cartridges 104a and 104b are received. Receptacles 112a and 112b partially receive and partially cover cartridges 104a and 104b. Cartridges 104a and 104b are, thus, partially exposed toward second end 128 of the vaporizer in this embodiment. However, embodiments are not limited to this particular arrangement of vaporizer device 100. In other embodiments, cartridges may be fully received in receptacles of the body and covered along their full lengths when received. In some embodiments, cartridges may be received through sides of the body rather than the end. The cartridges may simply dock to an attachment means (e.g. seat) on the outer periphery of the body rather than being partially received in a receptacle. Other variations are also possible.

In the FIG. 1 embodiment, vaporizer device 100 is portable, but embodiments are not limited to portable vaporizer device. For example, the concepts described herein may be applied to vaporizers comprising a base and body that docks with the base, where the body comprises two or more storage chambers (e.g. reservoirs) for vaping materials.

Embodiments are not limited to liquid vaping materials. In some embodiments, a vaporizing device may comprise at least one cartridge having a storage chamber for holding solid vaping materials such as dry herb. The storage chamber may be part of a dry herb oven. A combination of liquid and solid vaping materials may also be used. For example, a first heater and storage chamber of a vaporizer device may be for use with liquid vaping materials, while a second heater and storage chamber (e.g. in the form of an oven) may be for use with solid vaping materials.

FIG. 2 is a functional block diagram of the vaporizer device 100 of FIG. 1, showing additional details of the heating and airflow features of vaporizer device 100. Body 102, first and second cartridges 104a and 104b, and mouthpiece 106 are functionally represented as blocks or areas enclosed by dashed lines. The vaporizer may typically include a power source (not shown) such as a batter to power the various components, including heating elements 116a and 116b. The power source may be within body 102. Embodiments are not limited to any particular method of powering vaporizer device 100.

Reservoirs 108a and 108b are shown within cartridges 104a and 104b, respectively. As shown, first cartridge 104a includes first heater 114a, and second cartridge 104b includes second heater 114b.

First vaping material 110a (shown in FIG. 1) in first cartridge 104a flows from reservoir 108a to first heating chamber 115a via first fluid conduit 134a. First fluid conduit 134a may, for example, comprise a wick (not shown) that transports first vaping material 110a to the heating element 116a. However, embodiments are not limited to the use of wicks, and other mechanisms may be used to transport first vaping material 110a to heating element 116a. First heating element 116a is operable to vaporize first vaping material 110a to produce a first vapor.

Second vaping material 110b (shown in FIG. 1) in second cartridge 104b flows from second reservoir 108b to second heating chamber 115b via second fluid conduit 134b. Second fluid conduit 134b may, for example, comprise a wick (not shown) that transports second vaping material 110b to second heating element 116b. As noted above, however, embodiments are not limited to the use of wicks. Second heating element 116b is operable to vaporize second vaping material 110b to produce a second vapor.

In some embodiments, vaporizer device 100 includes airflow conduit system 117 that comprises a first vapor airflow conduit 136a, a second vapor airflow conduit 136b, and a mixed vapor airflow conduit 138. The first vapor flows out from first heating chamber 115a (e.g. via an outlet, not shown) into first vapor airflow conduit 136a. The second vapor flows out from second heating chamber 115b (e.g. via an outlet, not shown) into second vapor airflow conduit 136b. First and second airflow conduits 136a and 136b extend through body 102 and converge into mixed vapor airflow conduit 138 in mouthpiece 106. Mixed vapor airflow conduit 138 extends to at least one suction opening 140 in mouthpiece 106, such that a mix of the first and second vapors may be inhaled by a user though mouthpiece 106. In some embodiments, first and second vapor airflow conduits 136a and 136b may not converge, but may rather extend to separate suction openings in mouthpiece 106. In some embodiments, first and second vapor airflow conduits 136a and 136b may converge in body 102 rather than mouthpiece 106.

For each airflow conduit extending through body 102 and into mouthpiece 106, an airflow outlet of body 102 may align with airflow inlets of mouthpiece 106. For example, in the FIG. 2 embodiment, each of first and second airflow conduits 136a and 136b include outlets 150a and 150b of body 102 that align with inlets 151a and 151b of mouthpiece 106. First and second airflow conduits 136a and 136b further include inlets 153a and 153b of body 102 (e.g. located within receptacles 112a and 112b in FIG. 1) that align with outlets 152a and 152b of cartridges 104a and 104b. It will be appreciated that various structures may be used to provide such vapor airflow conduits 136a, 136b and 138.

In the FIG. 2 embodiment, vaporizer device 100 includes air inlets 141a and 141b that are in fluid communication with the outside environment 143 and heating chambers 115a and 115b. Air inlets 141a and 141b supply air from outside environment 143 to heating chambers 115a and 115b, where the air mixes with the corresponding first and second vapors. Air inlets 141a and 141b are each illustrated extending directly from corresponding cartridge 104a or 104b to outside environment 143. However, it is to be understood that air inlets 141a and 141b may also extend through body 102 in other embodiments (such as when heating chambers 116a and 116b are located in body 102).

In the embodiment shown in FIG. 2, vaporizer device 100 includes a user interface 142, a processor 144, a memory 145, and a vapor control 120. In the embodiment shown in FIG. 1, the user interface comprises a button 122 and a visual indicator 124. The user interface may be used to implement one or more child safety features. For example, button 122 may include a fingerprint sensor for user identification. Fingerprint identification information may be retrieved via wireless or wired connection from a remote device (such as a smart phone) and compared to sensor data from button 122. Alternatively, a particular input sequence may be required via button 122 to activate the vaporizer device. Other child safety features may also be implemented.

Optionally, vaporizer device 100 includes a clock 146 and/or a location module 147. Location module 147 obtains current location information and may be a Global Positioning System (GPS) module, for example. The vapor control 120 may obtain time and/or location information from the clock 146 and location module 147. Such information may also be obtained from other sources. In some embodiments, the location information may be retrieved via a wireless or wired connection to a smart phone (not shown). The smart phone may include the GPS module or other means of retrieving location information over a network.

User interface 142, vapor control 120, memory 145, clock 146 and location module 147 are operably connected to processor 144. Memory 145 may store processor-executable instructions thereon that, when executed, cause processor 144 to implement methods for controlling the vaporizer device described herein. In some embodiments, memory 145 and/or vapor control 120 are separate external components. In some embodiments, memory 145 and/or vapor control 120 are internal to processor 144. For example, vapor control 120 may be a module implemented by processor 144 and/or memory 145. Memory 145 may store instructions thereon that, when executed by processor 144, implement the vapor control functionality described herein. In some embodiments, memory 145 and/or vapor control 120 are separate external components from processor 144.

In the FIG. 2 embodiment, vaporizer device 100 includes optional first and second airflow baffles 148a and 148b positioned and configured to regulate airflow through first and second airflow conduits 136a and 136b, respectively. First and second airflow baffles 148a and 148b are controlled by vapor control 120 in this embodiment. Optionally, vaporizer device 100 may further include one or more airflow sensors that measure airflow through body 102, mouthpiece 106, and/or cartridges 104a and 104b. The sensor output may be provided to processor 144. Baffles 148a and 148b, thus, are airflow restriction mechanisms that selectively restrict flow of the first and/or second vapors.

A user may select a desired mode of operation using user interface 142. The mode of operation may be a mix ratio. For example, a user may press button 122 (FIG. 1) to cycle through available modes until the visual indicator 124 (FIG. 1) indicates a desired mix ratio of vapors from vaping materials in cartridges 104a and 104b. Processor 144, upon receiving user input, via user interface 142, directs vapor control 120 to control the flow of vapors through first and second vapor conduits 136a and 136b as a function of the selected mix ratio. Example methods for controlling the mix ratio will now be discussed, although embodiments are not limited to these specific examples.

Vapor control 120 may individually and selectively control heating elements 116a and 116b. For example, in some embodiments, the power level provided to heating elements 116a and 116b may be varied as a function of the selected mix ratio of vapors from vaping materials in cartridges 104a and 104b. For example, for a 50/50 mix ratio, the wattage provided to each of heating elements 116a and 116b may be the same (e.g. high power for both, or medium power for both). For a 75/25 mix ratio, the wattage may be high for first heating element 116a and low for second heating element 116b. In this context, high may be 100% max power and low may be 50% max power. However, the exact relative powers and power ratios may vary and may depend on the vaping materials being vaporized in first and second heating chambers 115a and 115b. For a 100/0 mix ratio, the output wattage may be 100% wattage for first heating element 116a and 0% for second heating element 116b.

As yet another option, timing and/or duration of the activation of heaters 114a and 114b may be a function of the desired mix ratio of vapors from vaping materials in cartridges 104a and 104b. The duration for which heating elements 116a and 116b of heaters 114a and 114b are activated to vaporize material may be referred to as a “burn time”. The burn time may, for example, be based on an expected (e.g. typical) inhale time of a user. For example, it may be assumed that the user will typically inhale for two seconds. For a 50/50 mix ratio (i.e. 50%), the burn times for both heating elements 116a and 116b may be the same. For example, both heating elements 116a and 116b may burn for approximately two seconds. For a 75/25 mix ratio (i.e. 75%), the burn time of second heater 114b may be reduced. As an example, first heating element 116a may burn for approximately two seconds and second heating element 116b may burn for approximately 0.5 seconds. For a 100/0 mix ratio (i.e. 100%), the burn time for first heater 114a may be approximately two seconds, and the burn time for second heater 114b may be zero. The burn times described above are only examples, and other different relative burn times may be used in other implementations.

As another option, heating elements 116a and 116b may be controlled to individually and selectively generate vapor at variable rates to provide the desired mix ratio of vapors from vaping materials in cartridges 104a and 104b. Heating elements 116a and 116b may be controlled by processor 144 to vary the rate of vapor production. For example, power to each of heating elements 116a and 116b may be “pulsed” at variable rates. For each heating element 116a and 116b, the respective “pulse rate” may determine the rate of vapor production. For example, a faster pulse rate may produce a higher flow of vapor than a slower pulse rate. The total airflow through conduits 168a and 168b may be approximately the same (or similar), but the density of vapor in the air that flows through such conduits may vary by this method.

For example, if the selected mix ratio is 100% of the first vapor and 0% the second vapor, heating element 116a may be pulsed to generate vapor while second heating element 116b is not pulsed at all. For a 50/50 mix ratio (i.e. 50%), each of heating elements 116a and 116b may be pulsed at the same rate(s). For a mix ratio that is 25% of the first vapor and 75% of the second vapor, first heating element 116a may be pulsed at a slower rate than second heating element 116b.

The specific pulse rate(s) of heating elements 116a and 116b may also vary dependent on other factors, such as heating chamber temperature, airflow rate (e.g. when a user is currently inhaling vs. when a user is not currently inhaling), and/or other factors. Thus, the pulse rate(s) for selected mix ratios may not be limited to a single pulse rate for each heating element 116a and 116b. In other embodiments, power levels supplied to heating elements 116a and 116b may be controlled to control the mix ratio.

In some embodiments, vaporizer device 100 may include a respective temperature sensor (not shown) for each of heaters 114a and 114b. The temperature sensors may be located within or near heaters 114a and 114b to measure the temperatures therein. Temperature feedback may be received by processor 144 and used to dynamically control the pulse rate(s) of heating elements 116a to 116b to maintain the respective temperatures within a set range.

In some embodiments, first and second airflow baffles 148a and 148b may be controlled by vapor control 120 to provide the selected mix ratio of vapors from vaping materials in cartridges 104a and 104b. For example, if the selected ratio is 100% of the first vapor and 0% of the second vapor, first baffle 148a may be fully opened and second baffle 148b may be fully closed. For a 50/50 mix ratio, each of baffles 148a and 148b may be fully open, or both may be partially open to the same degree, such that the vapor flow in each of first and second airflow conduits 136a and 136b is substantially similar. For a mix ratio that is 25% of the first vapor and 75% the second vapor, first baffle 148a may be only slightly open, while second baffle 148b is mostly open, where the difference in baffle positions is designed to give the proper mix. While a vapor is set to 0%, the heat element may be inactive for the corresponding heating chamber so that vapor is not produced.

Embodiments are not limited to baffles, and any other suitable mechanism controllable to modify airflow resistance may be used rather than baffles. Embodiments are also not limited to physical airflow resistance mechanisms for controlling vapor mix ratios.

In some embodiments, the vapor control system may comprise first and second electromagnetic switch elements. The magnetically controlled elements may each open and close an airflow conduit for a different vapor at variable and selective rates to achieve the desired mix ratio. For example, the first and second airflow conduits (e.g. airflow conduits 136a and 136b) for the first and second vapors may each have a respective electromagnetically controlled switch that can be rapidly opened or closed to block or allow airflow therethrough. Each of the first and second electromagnetically controlled switches may be controlled rapidly at relative rates necessary for the mix ratio. Thus, in this example, rather than controlling a pulse rate of the heater, a pulse rate of the electromagnetically controlled gate or switch is used to control vapor flow. The electromagnetic switch elements, thus, are alternate airflow restriction mechanisms that selectively restrict flow of the first and/or second vapors. Other physical airflow restriction mechanisms may also be used (e.g. variable apertures).

The first and second electromagnetic switches may be controlled so that one of the first and second vapour conduits is always open at any given time. For example, the first and second first and second electromagnetic switches may be activated in an alternating manner (between the first and second vapour conduits). In order to achieve a 50/50 mix ratio, the open and closed cycle for each switch may be equal. For a 25/75 mix ratio, the first conduit may have a shorter “open” portion of the open/close cycle, while the second conduit has a longer “open” portion of the open/close cycle. For a 100% to 0% mix ratio, the desired vapor conduit may be left open, and the other closed.

For each electromagnetic switch, a spring or other biasing element may be used to close the respective conduit, and an electromagnet, when activated, could open the conduit (similar to a solenoid switch, for example). In other words, the default position of the switch may be closed. In such embodiments, rather than activating the vaporizer device in response to sensing a user trying to draw vapor through the mouthpiece, a button may be used to control usage. As another option, a separate sensor configured to sense if someone is using the mouthpiece may be used. For example, the sensor may be a touch sensor on the mouthpiece.

In some embodiments, the current mode of operation (e.g. mix ratio) may be selected as a function of factors other than, or in addition to user input. The factors may include time of day or location information. For example, the mix ratio may be selected based on time of day and/or location information as obtained from clock 146 and/or location module 147, for example. For example, at certain times of the day (e.g. work hours) and/or locations (e.g. workplace) one of the first and second vapors may be restricted to 0%. For example, a vapor including one or more psychoactive components may be restricted to use during certain times of the day such as non-work or after-work hours. The vapor including one or more psychoactive components may be restricted to use in certain locations, such as non-work locations, or certain geographic regions. Restricting the flow of one of the vapors may comprise deactivating or disabling (not allowing) activation of corresponding heating element 116a or 116b.

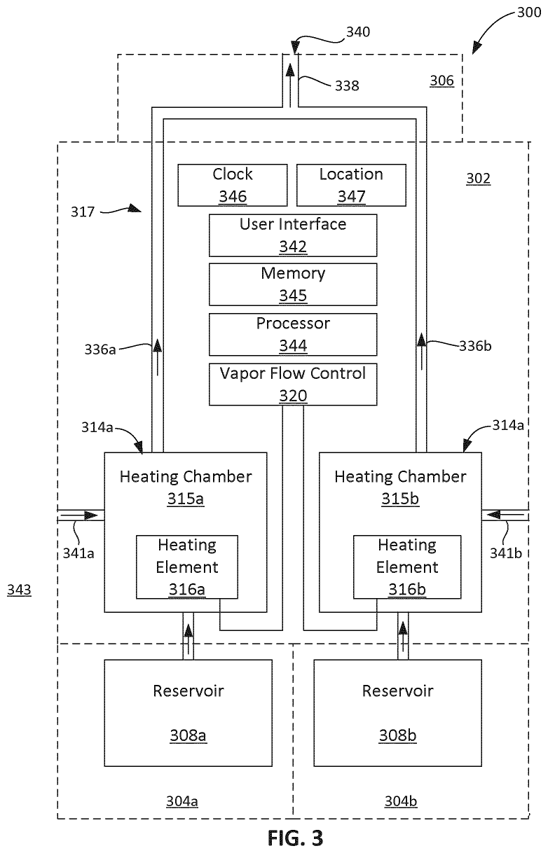

FIG. 3 is a block diagram of a vaporizer device 300 according to an example embodiment. Vaporizer device 300 is similar includes first and second cartridges 304a and 304b (having first and second reservoirs 308a and 308b respectively), a mouthpiece 306 with a suction opening 340, a body 302 having vapor control 320, a user interface 342, a processor 344, a memory 345, a clock 346, and a location module 347. These and other elements of the vaporizer 300 may be similar in structure and function to the corresponding elements shown in FIG. 1. As with other embodiments described herein, one or more elements of body 302 may be omitted.

In the FIG. 3 embodiment, vaporizer device 300 includes first and second heaters 314a and 314a, which may be similar to heaters 114a and 114b in vaporizer device 100 shown in FIG. 2. First heater 314a in FIG. 3 includes first heating chamber 315a and first heating element 316a coupled to first heating chamber 315a. Second heater 314b includes second heating chamber 315b and second heating element 316b coupled to second heating element 315b. However, in the FIG. 3 embodiment, heaters 314a and 314b are located in body 302, rather than in first and second cartridges 304a and 304b. Air inlets 341a and 341b are also located in body 302 in this embodiment, and air inlets 341a and 341b deliver air from the external environment 343 to heating chambers 315a and 315b. First and second vapor airflow conduits 336a and 336b carry the first and second vapors to mouthpiece 306 where they mix in mixed vapor airflow conduit 338 for delivery to suction opening 340.

The FIG. 3 embodiment omits baffles or other physical airflow control mechanisms in airflow conduit system 317. Instead, vapor control 320 controls production of the first and second vapors according to a current mode of operation by individually and selectively controlling first and second heating elements 316a and 316b. For example, vapor control 320 may individually control one or more of: power levels of first and second heating elements 316a and 316b; burn times of first and second heating elements 316a and 316b; or pulse rates of first and second heating elements 316a and 316b.

Optionally, the mode of operation may be selected by a user via a user interface 342. The mode of operation may also be automatically selected by vapor control 320 and/or processor 344 based on time of day and/or location information.

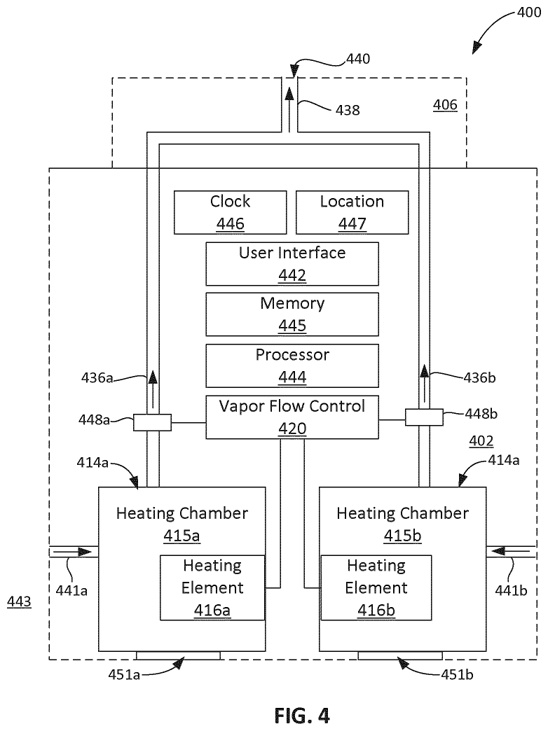

FIG. 4 is a block diagram of a vaporizer device 400 according to an example embodiment. Vaporizer device 400 comprises a body 402 including first and second heaters 414a and 414b. Heaters 414a and 414b are in the form of dry herb ovens. First oven 414a defines first heating chamber 415a and includes first heating element 416a coupled to first heating chamber 415a. Second oven 414b defines second heating chamber 415b and includes second heating element 416b coupled to second heating chamber 415b. First and second heating elements 416a and 416b are configured to heat dry herb in ovens 414a and 414b respectively to generate first and second vapors. No removable or replaceable cartridges are included in this example. Rather, the herbs in ovens 414a and 414b are internal to body 402, and a user may add one or more dry herb compositions to ovens 414a and 414b. Closure members 451a and 451b cover openings in ovens 414a and 414b and may be removed by the user to provide access to ovens 414a and 414b.

In some embodiments, body 402 includes a user interface 442, a processor 444, a memory 445, a clock 446, and a location module 447 that are similar to the corresponding elements in vaporizer devices 100 and 300 shown in FIGS. 2 and 3.

Air inlets 441a and 441b are also located in body 402 in the FIG. 4 embodiment, and air inlets 441a and 441b deliver air from the external environment 443 to ovens 414a and 414b. First and second vapor airflow conduits 436a and 436b carry the first and second vapors to mouthpiece 406 where they mix into conduit 438 for delivery to suction opening 440.

In some embodiments, vaporizer device 400 comprises electromagnetic switches 448a and 448b positioned in first and second vapor flow conduits 436a and 436b. Vapor control 420 may control production of the first and second vapors according to a current mode of operation by operating electromagnetic switches 448a and 448b. Vapor control 420 may also individually and selectively control first and second heating elements 416a and 416b.

Optionally, the mode of operation may be selected by a user via user interface 442. The mode of operation may also be automatically selected by vapor control 420 and/or processor 444 based on time of day and/or location information, as described elsewhere herein. As with other embodiments described herein, one or more of these elements of vaporizer device 400 may be omitted.

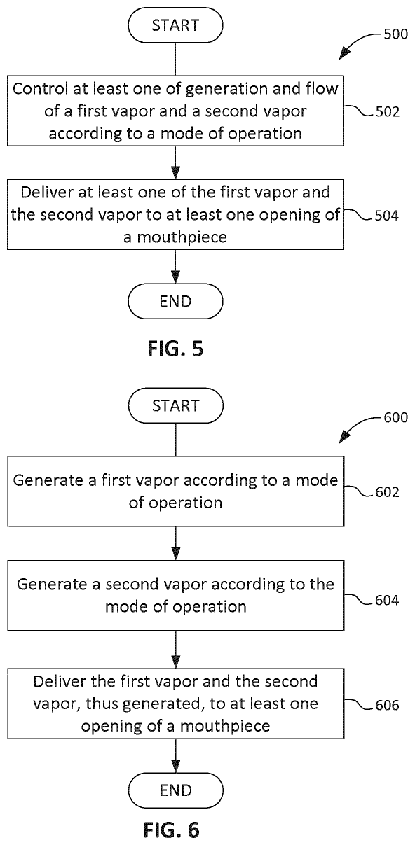

FIG. 5 is a flowchart of a method 500 for vaporizing at least one vaping material using a vaporizer device, such as the vaporizer devices 100, 300 or 400 of FIGS. 1 to 4, according to an example embodiment. Method 500 may, for example, be implemented by a vapor control, such as vapor control 120, 320 or 420 shown in FIGS. 2 to 4.

At block 502, at least one of generation and flow of a first vapor and a second vapor is controlled according to a mode of operation. The first vapor may be generated by vaporizing a first vaping material in a first heater. The second vapor may be generated by vaporizing a second vaping material in a second heater.

Controlling the generation of the first and second vapors may comprise selectively and individually controlling first and second heating elements, as described above. For example, the controlling may comprise controlling power, pulse rate, and/or burn time for each of the heating elements, as described elsewhere herein. The mode of operation may be one of a plurality of modes of operation (e.g. for different mix ratios of the first and second vapors, where each of the plurality of mix ratios corresponds to a respective one of the modes of operation). The vapor control may be selectively operable for each of the modes of operation.

Controlling flow of the first and second vapors may comprise controlling one or more physical flow control mechanisms. For example, the controlling may comprise selectively activating or controlling one or more baffles or electromagnetic switch elements in at least one airflow conduit, as described elsewhere herein.

At block 504, the first and/or second vapors, thus controlled, are delivered to at least one opening of a mouthpiece of the vaporizer (e.g. mouthpiece 106, 306 or 406 in FIGS. 2 to 4). The first and/or second vapors may be delivered to the at least one suction opening via at least one airflow conduit.

FIG. 6 is a flowchart of a method 600 for vaporizing at least one vaping material using a vaporizer device, such as the vaporizer devices 100, 300 or 400 of FIGS. 1 to 4, according to an example embodiment. Method 600 may, for example, be implemented by a vapor control, such as vapor control 120, 320 or 420 shown in FIGS. 2 to 4.

At block 602, a first vapor is generated according to a mode of operation. Generating the first vapor according to the mode of operation may comprise restricting generation during certain times of the day and/or location(s). Generating the first vapor according to the mode of operation may comprise generating the first vapor according to a particular mix ratio with the second vapor, where the mix ratio corresponds to the mode of operation.

At block 604, a second vapor is generated according to the mode of operation. Generating the second vapor according to the mode of operation may comprise restricting generation during certain times of the day and/or location(s). Generating the second vapor according to the mode of operation may comprise generating the second vapor according to a particular mix ratio with the first vapor, where the mix ratio corresponds to the mode of operation.

Generating the first and second vapors may comprise selectively and individually controlling the first and second heating elements, as described elsewhere herein. For example, the controlling may comprise controlling power, pulse rate, and/or burn time for each of the heating elements.

At block 606, the first vapor and the second vapor, thus generated, are delivered to at least one opening of a mouthpiece. The first and/or second vapors may be delivered to the at least one opening via at least one airflow conduit.

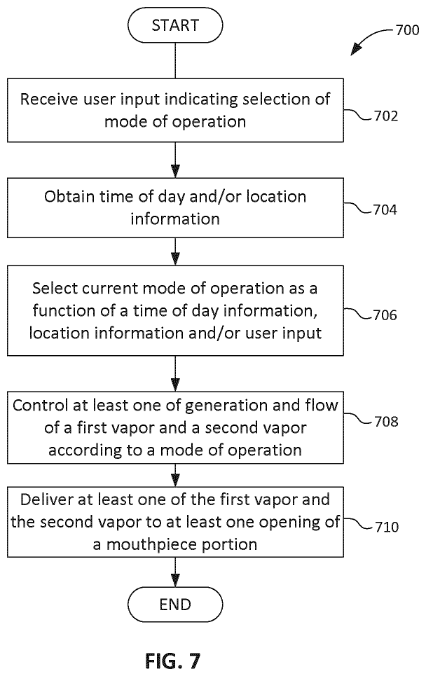

FIG. 7 is a flowchart of a method 700 for vaporizing at least one vaping material using a vaporizer device, such as the vaporizer devices 100, 300 or 400 of FIGS. 1 to 4, according to an example embodiment. Method 700 may, for example, be implemented by a vapor control, such as vapor control 120, 320 or 420 shown in FIGS. 2 to 4.

At block 702, user input is received indicating a selection of a current mode of operation. The user input may, for example, indicate a selection a mix ratio (e.g. 0%, 25%, 50%, 75% or 100% of a first vapor or a second vapor). The user may input may also simply indicate a selection between 100% of the first vapor and 100% of the second vapor. The input may be received on any user input device (e.g. one or more buttons, touch screen, etc.).

At block 704, current time and/or current location information is obtained. The current time of day may be received from a clock inside the device, for example. The current location information may be obtained by a location tracking module, such as a GPS module. As another example, the location information may be received over a network (e.g. Wi-Fi communication network and/or the Internet). Any suitable method for obtaining current location information may be used. The current location information may comprise an approximate location or a geographic region.

At block 706, the current mode of operation is selected as a function of at least one of: a current time of day; current location information; and the user input. The current time of day and the current location information may correspond to a time range or a geographic region where either the first or second vapor is restricted. Such restrictions may take priority over a user input selection of a mode of operation. For example, if the user selects a 50/50 mix ratio, but the current location corresponds to a workplace, then the first or second vapor may be restricted to 0% despite the user selection.

In some embodiments, block 702 is omitted, and a mode of operation is selected solely as a function of the time of day or location. In some embodiments, block 704 and/or 706 is omitted, and the mode of operation depends only on a user selection. In other embodiments, upon start-up or power-up of the device, the mode of operation may be a previously selected mode of operation (e.g. from the previous vaping session). In some embodiments, the vaporizer device may have a default mode of operation upon start-up (e.g. only the first or second vapor).

At block 708, at least one of generation and flow of a first vapor and a second vapor is controlled according to the mode of operation.

At block 710, the first and/or second vapors, thus controlled, are delivered to at least one opening of a mouthpiece of the vaporizer (e.g. the mouthpiece 106, 306 or 406 in FIGS. 2 to 4).

The methods 500, 600 and/or 700 of FIGS. 5 to 7 may be implemented by hardware (e.g. a processor of the vaporizer device), software (e.g. computer executable instructions stored on a memory of the device), or a combination of hardware and software. For example, the vaporizer device may include a processor and memory storing instructions that, when executed by the processor, cause the processor to implement the method(s) described herein. The processor and/or memory may, thus, implement a vapor control module as described herein. Other combinations of hardware and/or software may be used to implement the functionality of the vapor control module. In some embodiments, various combinations of steps of the methods 500, 600 and/or 700 of FIGS. 5 to 7 may be implemented. In some embodiments, one or more steps of the methods 500, 600 and/or 700 may be omitted. Embodiments are not limited to the particular combinations of features shown in the drawings.

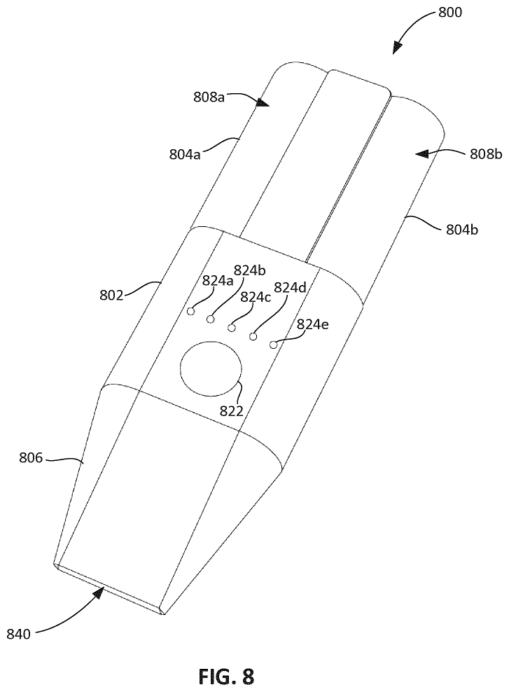

FIG. 8 is a perspective view of a portable vaporizer device 800 according to an example embodiment. Vaporizer device 800 comprises a body 802, a mouthpiece 806, and first and second cartridges 804a and 804b having first and second vaping material reservoirs 808a and 808b, respectively. Vaporizer device 800 is similar in general construction to vaporizer device 100 in FIGS. 1 and 2 in that cartridges 804a and 804b are at least partially received in receptacles (not shown) defined by body 802, and first and second vapors are created from the vaping material(s) in reservoirs 808a and 808b by first and second heaters (not shown). The first and second vapors are delivered to one or more openings 840 of mouthpiece 806 through at least one airflow conduit (not shown) through device 800.

As with the other embodiments described herein, the first and second vapors may be selectively delivered to mouthpiece 806 according to a current mode of operation. For example, the vapors may have a selected mix ratio or one of the vapors may be restricted based on factors such as time of day and location. For example, vaporizer device 800 may comprise one or more of a vapor control, processor, memory, one or more baffles, and or other components similar to the vaporizer devices 100, 300, or 400 shown in FIGS. 1 to 4.

As shown in FIG. 8, vaporizer device 800 comprises a button 822 on body 802 for receiving user input to select the current mode of operation (e.g. mix ratio). Vaporizer device 800 also includes five visual indictor lights 824a to 824e (e.g. LED lights) that may each indicate a different mode of operation (e.g. mix ratio) when lit. For example, a first light 824a may indicate a mix ratio of 100% of the first vapor and 0% of the second vapor; a fifth light 824e may indicate a mix ratio of 0% of the first vapor and 100% of the second vapor; and the second, third and fourth lights 824b to 824d may indicate intermediate mix ratios (e.g. 25/75, 50/50, 85/25, etc.).

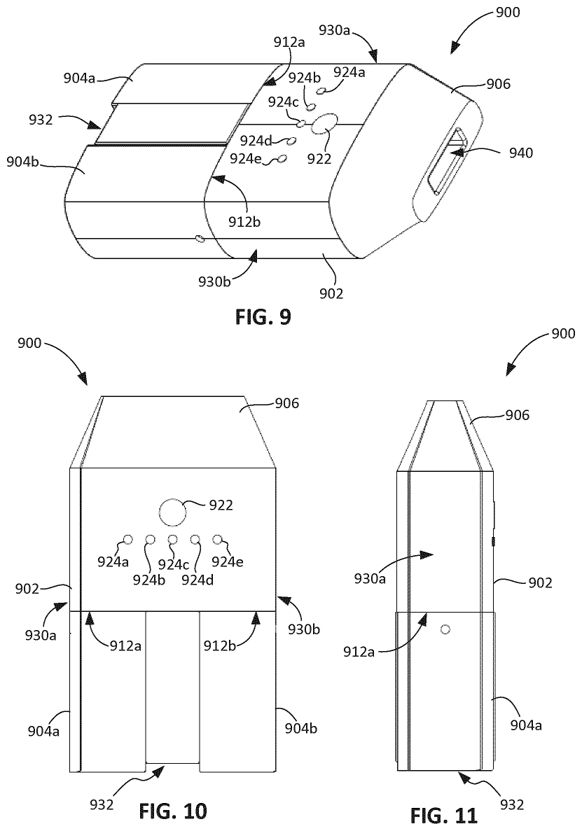

FIGS. 9 to 11 are upper perspective, top plan, and side elevation views, respectively, of a portable vaporizer device 900 according to an example embodiment. Vaporizer device 900 is generally similar to the vaporizer devices 100 and 800 shown in FIGS. 1, 2 and 8. Vaporizer device 900 includes a body 902, a mouthpiece 906, and first and second cartridges 904a and 904b having first and second vaping material reservoirs 908a and 908b (shown in FIG. 13), respectively. Cartridges 904a and 904b dock with receptacles 912a and 912b (best shown in FIG. 13) defined by body 902. First and second vapors are generated from the vaping material(s) in reservoirs 908a and 908b by first and second heaters 914a and 914b (shown in FIG. 13). The first and second vapors are delivered to suction opening 940 (FIG. 9) of mouthpiece 906 through at least one airflow conduit (not shown) through device 900.

In this embodiment, receptacles 912a and 912b are in the form of nooks or recesses in opposite sides 930a and 930b of body 902. The receptacles 912a and 912b extend from an end 932 of body 902, opposite mouthpiece 906, toward mouthpiece 906. Cartridges 904a and 904b may connect to body 902 in any suitable manner, and embodiments are not limited to any particular way of retaining cartridges 904a and 904b in the receptacles 912a and 912b.

As with the other embodiments described herein, the first and second vapors may be selectively delivered to mouthpiece 906 according to a current mode of operation. For example, the vapors may have a selected mix ratio or one of the vapors may be restricted based on factors such as time of day and location. For example, vaporizer device 900 may comprise one or more of a vapor control, processor, memory, one or more baffles, and or other components similar to the vaporizer devices 100, 300, or 400 shown in FIGS. 1 to 4. Cartridges 904a and 904b are opaque in this embodiment, such that reservoirs 908a and 908b (shown in FIG. 13) are not visible.

As shown in FIGS. 9 and 10, vaporizer device 900 comprises a button 922 on body 902 for receiving user input to select the current mode of operation (e.g. mix ratio). Vaporizer device 900 also includes five visual indictor lights 924a to 924e (e.g. LED lights) that may each indicate a different mode of operation (e.g. mix ratio) when lit, similar to lights 824a to 824e of the embodiment of FIG. 8.

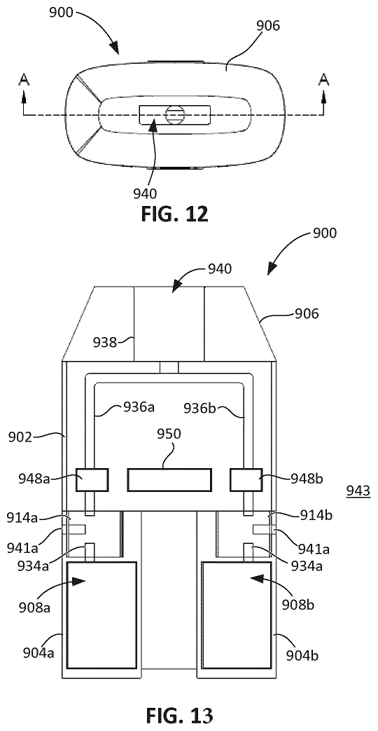

FIG. 12 is an end view of vaporizer device 900 showing the suction opening 940 of mouthpiece 906.

FIG. 13 is a top cross-sectional view of vaporizer device 900 taken along line A-A in FIG. 12. In FIG. 13, first and second reservoirs 908a and 908b are visible in first and second cartridges 904a and 904b respectively.

The reservoirs 908a and 908b are fluidly coupled to first and second heaters 914a and 914b respectively by fluid conduits 934a and 934b. Each of the fluid conduits 934a and 934b may comprise a respective wick, for example. First and second heaters 914a and 914b are also within cartridges 904a and 904b in this embodiment. First and second heaters 914a and 914b receive and vaporize first and second vaping materials from the first and second reservoirs 908a and 908b respectively. Air inlets 941a and 941b that draw in air from external environment 943 are also shown.

First and second vapor airflow conduits 936a and 936b are fluidly coupled to first and second heaters 914a and 914b respectively. First and second vapor airflow conduits 936a and 936b carry the first and second vapors respectively to mouthpiece 906 where they mix in mixed vapor airflow conduit 938 for delivery to suction opening 940. Alternatively, first and second vapor airflow conduits 936a and 936b may converge in body 902 rather than mouthpiece 906. As another option, first and second vapor airflow conduits 936a and 936b may fluidly connect to separate suction openings.

Optional airflow restriction mechanisms 948a and 948b (such as baffles and/or electromagnetic switches) are shown coupled to first and second vapor airflow conduits 936a and 936b respectively for controlling vapor flow therethrough. A printed circuit board (PCB) 950 is shown in body 902. The PCB may include components such as a processor and memory. The memory and processor may implement a vapor control having the same or similar function as other vapor controls 120, 320 and 420 shown in FIGS. 2 to 4 and described herein. Alternatively, the vapor control may comprise circuitry external to the processor and memory. The PCB may be operatively connected to control heaters 914a and 914b and/or airflow restriction mechanisms 948a and 948b.

Embodiments are not limited to devices using fluid reservoirs with oils or other vaporizing fluids. In some embodiments, a vaporizer device body or cartridges may comprise one or more storage chambers for other types of vaping materials to be vaporized (rather than fluids). For example, the vaporizer device may comprise two chambers that hold various solid or semi-solid vaping materials including, but not limited to: wax-based compositions, such as wax mixed with dried plant materials or extracts; dry materials, such as dried plant materials; or a combination thereof. The heating chamber(s) may also function as material storage chambers.

Embodiments are not limited to two heaters. Three or more heaters including respective heating chambers and heating elements for generating up to three different vapors may be provided. Similarly, three or more cartridges and/or reservoirs or other storage chambers for vaping materials may be provided. In some embodiments, a single heating chamber and heating element may vaporize two or more vaping materials to form two or more vapors according to a mode of operation. For example, two liquid compositions may be provided to the same heating chamber (e.g. via two or more fluid connections).

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A vaporizer device, comprising:
a body;
a first heater for vaporizing a first vaping material, the first heater being arranged in or operatively coupled to the body;
a second heater for vaporizing a second vaping material, the second heater being arranged in or operatively coupled to the body; and
a mouthpiece coupled to the body, the mouthpiece defining at least one opening; and
at least one airflow conduit fluidly connecting the first and second heaters to the at least one opening of the mouthpiece.

2. The vaporizer device of claim 1, further comprising a vapor control operable to control at least one of generation and flow of a first vapor from the first vaping material and a second vapor from the second vaping material according to a mode of operation.

3. The vaporizer device of claim 2, wherein controlling the at least one of generation and flow of the first and second vapors according to the mode of operation comprises controlling the at least one of generation and flow of the first vapor and second vapors according to a mix ratio of the first and second vapors.

4. The vaporizer device of claim 3, wherein the mode of operation is one of a plurality of modes of operation, the mix ratio is one of a plurality of mix ratios, each of the plurality of mix ratios corresponding to a respective one of the modes of operation, and the vapor control being selectively operable for each of the modes of operation.

5. The vaporizer device of claim 2, wherein the vapor control is operable to control generation of the first and second vapors by individually and selectively controlling operation of the first and second heaters.

6. The vaporizer device of claim 5, wherein the vapor control is operable to selectively and individually control at least one of: power levels of the first and second heaters; burn times of the first and second heaters; and pulse rates of the first and second heaters.

7. The vaporizer device of claim 2, wherein the at least one airflow conduit comprises a first airflow conduit that fluidly connects to the first heater and a second airflow conduit that fluidly connects to the second heater, and
the vapor control comprises a first airflow restriction mechanism operable to selectively restrict airflow in the first airflow conduit and a second airflow restriction mechanism operable to selectively restrict airflow in the second airflow conduit.

8. The vaporizer device of claim 2, further comprising a user interface that receives user input to select the mode of operation.

9. The vaporizer device of claim 2, wherein the vapor control is operable to: obtain at least one of time of day information and location information; and select the mode of operation as a function of at least one of the time of day information and the location information.

10. The vaporizer device of claim 9, wherein the selected mode of operation restricts the generation or flow of one or more of the first and second vapors.

11. The vaporizer device of claim 1, further comprising a first storage chamber for storing the first vaping material and a second storage chamber for storing the second vaping material.

12. The vaporizer device of claim 11, further comprising a first cartridge removably couplable to the body, the first cartridge defining the first storage chamber.

13. The vaporizer device of claim 12, wherein the body defines a first receptacle, and the first cartridges docks with the first receptacle.

14. The vaporizer device of claim 12, wherein the first cartridge further comprises the first heater.

15. The vaporizer device of claim 12, further comprising a second cartridge removably couplable to the body, the second cartridge defining the second storage chamber.

16. The vaporizer device of claim 15, wherein the body defines a second receptacle, and the second cartridges docks with the second receptacle.

17. The vaporizer device of claim 15, wherein the second cartridge further comprises the second heater.

18. The vaporizer device of claim 1, wherein at least one of the first and second heaters are arranged in the body.

19. The vaporizer device of claim 11, wherein the first storage chamber comprises a first reservoir fluidly coupled to the first heater.

20. The vaporizer device of claim 19, wherein the second storage chamber comprises a second reservoir fluidly coupled to the second heater.

21. The vaporizer device of claim 11, wherein the first heater comprises a first oven, the first oven defining the first storage chamber.

22. The vaporizer device of claim 21, wherein the second heater comprises a second oven, the second oven defining the first storage chamber.

23. A vaporizer device, comprising:
a body defining: a first cartridge receptacle operable to engage a first cartridge, the first cartridge holding a first vaping material and comprising a first heater for vaporizing the first vaping material; and a second cartridge receptacle operable to engage a second cartridge, the second cartridge holding a second vaping material and comprising a second heater for vaporizing the second vaping material;
a mouthpiece coupled to the body, the mouthpiece defining at least one opening; and
at least one airflow conduit fluidly connecting the first and second receptacles to the at least one opening of the mouthpiece.

24-33. (canceled)
